(19) United States
(12) Patent Application Publication
(10) Pub. No.: US 2008/0052735 A1
(43) Pub. Date: Feb. 28, 2008

(54) Optical devices

(75) Inventors: Yu Chien Huang, Taipei City (TW); Mu Hsuian Cheng, Taipei County (TW); Tzu Kan Chen, Taipei City (TW); Hsu Ting Cheng, Taoyuan County (TW); Chia Hsi Tsai, Taipei City (TW)

Correspondence Address: QUINTERO LAW OFFICE, PC, 2210 MAIN STREET, SUITE 200, SANTA MONICA, CA, 90405, US

(73) Assignee: LITE-ON TECHNOLOGY CORPORATION, TAIPEI (TW)

(21) Appl. No.: 11/555,820

(22) Filed: Nov. 2, 2006

(30) Foreign Application Priority Data
Aug. 23, 2006 (TW) TW95214925

(51) Int. Cl. G11B 7/00

(52) U.S. Cl. 720/683

(57) ABSTRACT

An optical device. A first yoke is connected to a support base. A second yoke is connected to the support base and opposes the first yoke. A lens module is movably disposed in the support base and between the first and second yokes. At least one magnetic member is comnected to the lens module and disposed between the first and second yokes. A coil is connected to the support base and disposed between the first and second yokes. The coil surrounds the magnetic member and lens module and is separated from the magnetic member. At least one elastic suspension rod is connected to the support base and lens module, supporting the lens module.

### BACKGROUND OF THE INVENTION

1. Field of the Invention

The invention relates to optical devices, and in particular to optical devices with reduced power consumption providing multi-focusing operations.

2. Description of the Related Art

Digital cameras are widely applied in cellular phones, personal digital assistants (PDA), portable media players, etc, providing photographic functions.

Conventional optical focus mechanisms in the digital cameras can be categorized as manual macro focus, automatic focus, and auto-macro focus mechanisms.

With the manual macro focus mechanism, a lever on the outside thereof is pushed by fingers of an operator, thereby activating a spring disposed on the periphery of a lens module in the interior of the manual macro focus mechanism. The lens module can then move backward and forward in two steps, thus performing zoom-in and zoom-out photographic operations. The manual macro focus mechanism, however, has many drawbacks. As the lever on the outside of the manual macro focus mechanism is connected to the spring disposed on the periphery of the lens module in the interior thereof, external particles easily enter the manual macro focus mechanism. Moreover, as the manual macro focus mechanism has miscellaneous components and the lever structure occupies an entire side thereof, the overall size thereof is excessive. Furthermore, to comply with EMI controls, an anti-electromagnetic area covering the manual macro focus mechanism is broad. Additionally, as focus movement of the lens module is manually performed with the lever, operation of the manual macro focus mechanism is inconvenient.

In the automatic focus mechanism, a lens module thereof is moved to a certain focus position by a voice coil motor. No matter the focus position to which the lens module is moved, electricity (or a holding current) must be continuously supplied thereto, maintaining the lens module in the focus position. Accordingly, considerable power is consumed by the automatic focus mechanism, adversely affecting portability or duration thereof. Moreover, as the automatic focus mechanism has many components, the size and manufacturing costs thereof cannot be reduced.

In the auto-macro focus mechanism, two zoom-in and zoom-out focus or photographic operations are performed automatically. No electricity (or holding current) is required when a lens module of the auto-macro focus mechanism reaches a focus position. Nevertheless, depths of field provided by the zoom-in and zoom-out focus operations of the auto-macro focus mechanism cannot comply with all photographic requirements. Namely, when a target being photographed is not within the set depths of field provided by the zoom-in and zoom-out focus operations, MTF thereof is reduced. A poor image of the target is thus captured.

Hence, there is a need for optical devices reducing power consumption and providing multi-focusing operations.

### BRIEF SUMMARY OF THE INVENTION

A detailed description is given in the following embodiments with reference to the accompanying drawings.

An exemplary embodiment of the invention provides an optical device comprising a support base, a first yoke, a second yoke, a lens module, at least one magnetic member, a coil, and at least one elastic suspension rod. The first yoke is comnected to the support base. The second yoke is comnected to the support base and opposes the first yoke. The lens module is movably disposed in the support base and between the first and second yokes. The magnetic member is connected to the lens module and disposed between the first and second yokes. The coil is connected to the support base and disposed between the first and second yokes. The coil surrounds the magnetic member and lens module and is separated from the magnetic member. The elastic suspension rod is connected to the support base and lens module, supporting the lens module.

The optical device further comprises an image sensor disposed in the exterior of the support base and adjacent to the first or second yoke.

The magnetic member surrounds the lens module.

The support base comprises a first opening and a second opening opposite thereto. The first yoke surrounds the first opening. The second yoke surrounds the second opening. The lens module is between the first and second openings.

The lens module comprises a lens housing and a lens disposed therein.

### BRIEF DESCRIPTION OF THE DRAWINGS

The invention can be more fully understood by reading the subsequent detailed description and examples with references made to the accompanying drawings, wherein:

FIG. 1A is a partial perspective view of an optical device of a first embodiment of the invention;

FIG. 1B is a partial exploded view of the optical device of the first embodiment of the invention;

FIG. 2A is a schematic view of the inner structure of the optical device, of the first embodiment of the invention, in a first operation mode;

FIG. 2B is a schematic view of the inner structure of the optical device, of the first embodiment of the invention, in a second operation mode;

FIG. 2C is a schematic view of the inner structure of the optical device, of the first embodiment of the invention, in a third operation mode; and

FIG. 3 is a partial perspective view of an optical device of a second embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

### First Embodiment

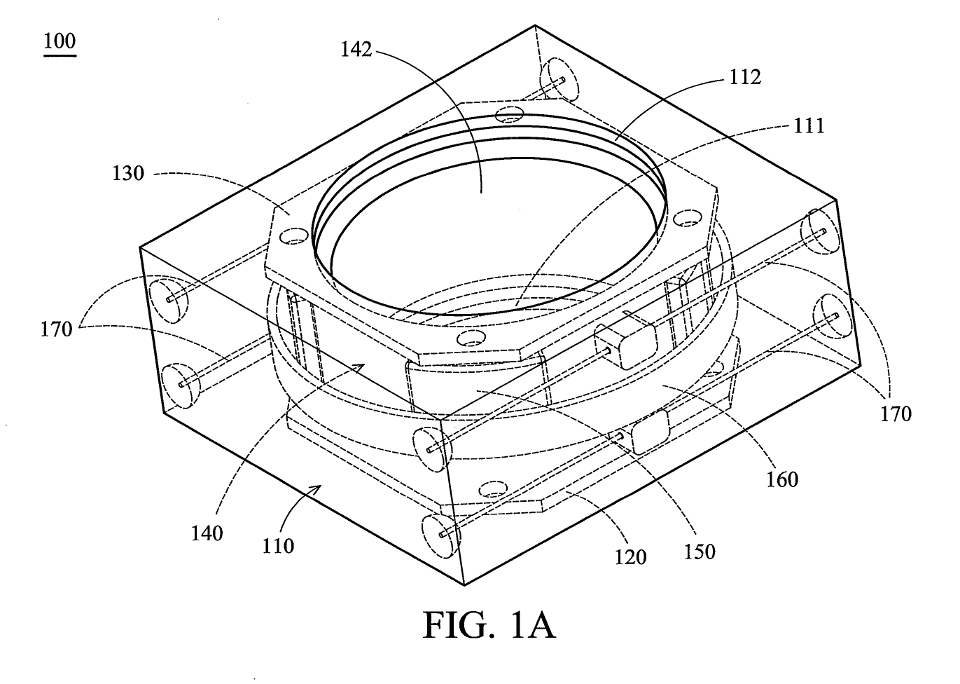

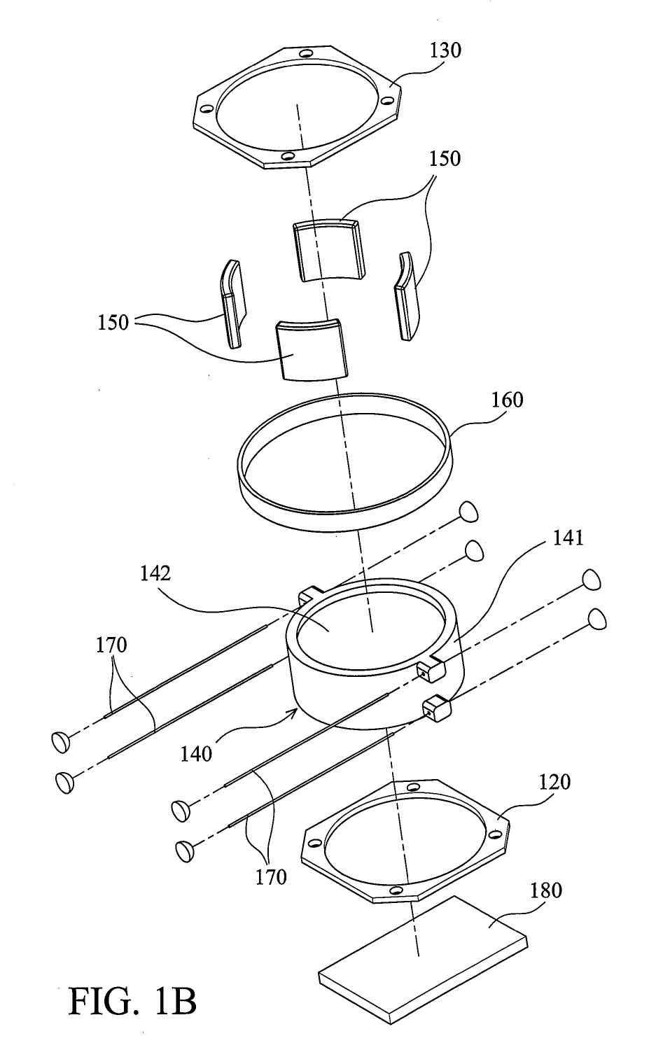

Referring to FIG. 1A and FIG. 1B, an optical device 100 comprises a support base 110, a first yoke 120, a second yoke 130, a lens module 140, a plurality of magnetic members 150, a coil 160, a plurality of elastic suspension rods 170, and an image sensor 180.

The support base 110 comprises a first opening 111 and a second opening 112 opposite thereto.

The first yoke 120 and second yoke 130 are connected to the support base 110. The first yoke 120 opposes the second yoke 130. Specifically, the first yoke 120 surrounds the first opening 111 of the support base 110, and the second yoke 130 surrounds the second opening 112 thereof. Moreover, the first yoke 120 and second yoke 130 may have the same size and profile and comprise the same material.

The lens module 140 is movably disposed in the support base 110. Specifically, the lens module 140 is disposed between the first yoke 120 and the second yoke 130 and between the first opening 111 and second opening 112 of the support base 110. Moreover, the lens module 140 comprises a lens housing 141 and a lens 142 disposed therein.

The magnetic members 150 are connected to the lens module 140. Specifically, the magnetic members 150 are connected to the outer periphery of the lens module 140 and between the first yoke 120 and the second yoke 130. Moreover, the magnetic members 150 may have the same size and profile and provide the same magnetic flux density or strength of magnetic field.

The coil 160 is connected to the support base 110 and between the first yoke 120 and the second yoke 130. Specifically, the coil 160 surrounds the magnetic members 150 and lens module 140 and is separated from the magnetic members 150. Moreover, the direction of magnetic lines or magnetic field provided by the magnetic members 150 is parallel to the radial direction of the coil 160. Namely, the direction of the magnetic lines or magnetic field provided by the magnetic members 150 is perpendicular to the direction of the current in the coil 160.

The elastic suspension rods 170 are symmetrically connected to the support base 110 and lens module 140, supporting the lens module 140. In this embodiment, each elastic suspension rod 170 is fixed to two sides of the support base 110 via the outer periphery of the lens module 140. Moreover, by analysis of magnetic force produced between the magnetic members 150 and the first yoke 120 or second yoke 130, the elastic suspension rods 170 may comprise a material having the same and suitable rigidity or Yotung's modulus, such that the lens module 140 is supported thereby and the elastic suspension rods 170 properly and elastically deformed during movement of the lens module 140.

The image sensor 180 is disposed in the exterior of the support base 110 and selectively adjacent to the first yoke 120 or second yoke 130. In this embodiment, the image sensor 180 is adjacent to the first yoke 120.

The following description is directed to operation of the optical device 100.

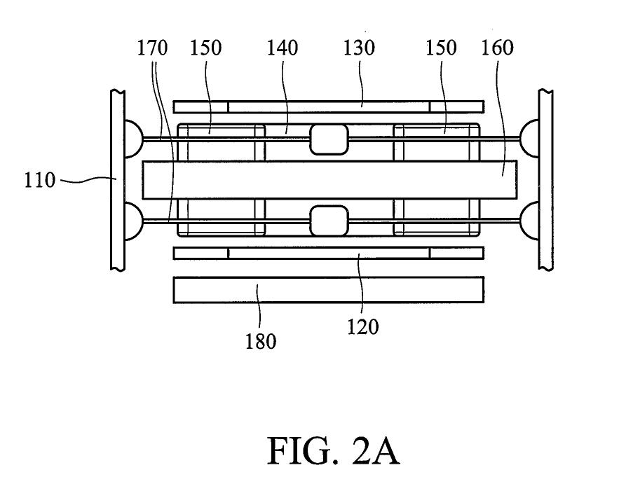

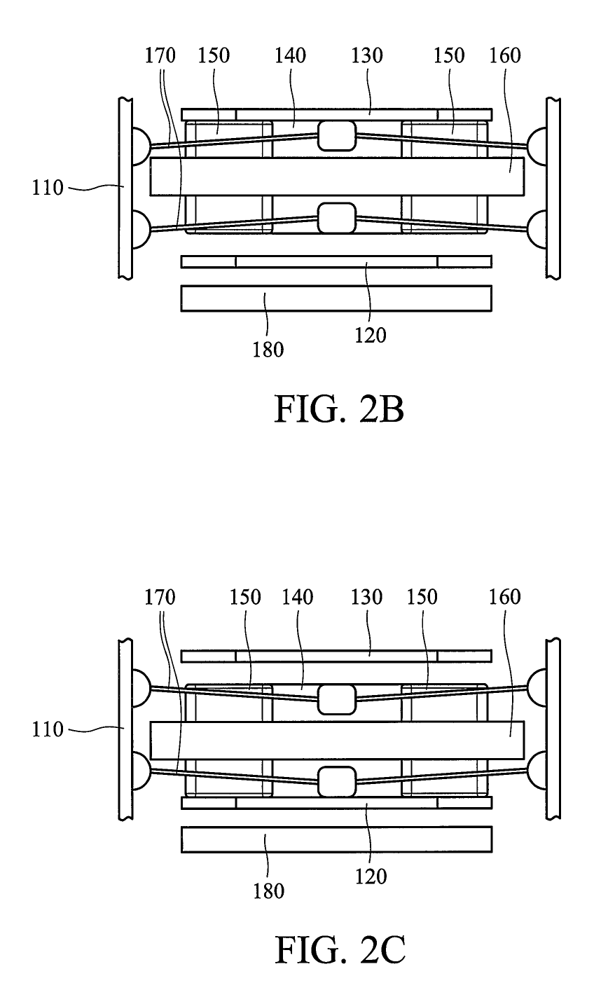

Referring to FIG. 2A, when the coil 160 is not energized by application of a current, the lens module 140 is supported by the elastic suspension rods 170 and in a middle position between the first yoke 120 and the second yoke 130. At this point, the optical device 100 is in a first operation mode (portrait mode). Namely, the focus distance of the lens module 140 is set for capturing an image in a middle distance.

In another aspect, as shown in FIG. 2B, the coil 160 can be energized by application of a current in a direction, interacting with the magnetic lines (or magnetic field) provided by the magnetic members 150 according to the Lorentz law, thereby generating an upward magnetic force. The upward magnetic force forces the lens module 140 to move toward the second yoke 130 until the lens module 140 abuts the second yoke 130. The coil 160 is then not energized by application of the current and the magnetic members 150 connected to the outer periphery of the lens module 140 attract the second yoke 130, fixing the lens module 140 to the second yoke 130. At this point, the optical device 100 is in a second operation mode (macro mode). Namely, the focus distance of the lens module 140 is set for capturing an image in a short distance. Specifically, when the lens module 140 moves to abut the second yoke 130, the elastic suspension rods 170 are elastically deformed. As attraction force between the magnetic members 150 and the second yoke 130 exceeds resilience provided by the elastic suspension rods 170, the lens module 140 and second yoke 130 are fixed together.

In yet another aspect, as shown in FIG. 2C, the coil 160 can be energized by application of a current in the other direction, interacting with the magnetic lines (or magnetic field) provided by the magnetic members 150 according to the Lorentz law, thereby generating an downward magnetic force. The downward magnetic force forces the lens module 140 to move toward the first yoke 120 until the lens module 140 abuts the first yoke 120. The coil 160 is then not energized by application of the current and the magnetic members 150 connected to the outer periphery of the lens module 140 attract the first yoke 120, fixing the lens module 140 to the first yoke 120. At this point, the optical device 100 is in a third operation mode (scenery mode). Namely, the focus distance of the lens module 140 is set for capturing an image in a long distance or an infinite position. Similarly, when the lens module 140 moves to abut the first yoke 120, the elastic suspension rods 170 are elastically deformed. As attraction force between the magnetic members 150 and the first yoke 120 exceeds the resilience provided by the elastic suspension rods 170, the lens module 140 and first yoke 120 are fixed together.

### Second Embodiment

Elements corresponding to those in the first embodiment share the same reference numerals.

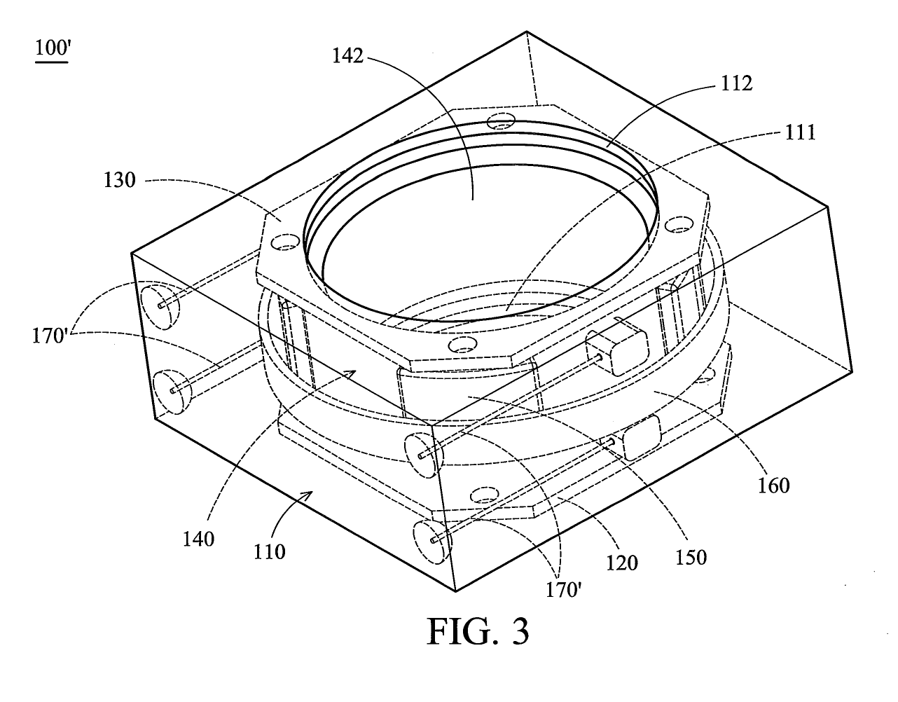

Referring to FIG. 3, in an optical device 100′, a plurality of elastic suspension rods 170′ are symmetrically connected between the support base 110 and the lens module 140, supporting the lens module 140. Namely, two ends of each elastic suspension rod 170′ are respectively fixed to one side of the support base 110 and the lens module 140.

Compared with the optical device 100, the elastic suspension rods 170′ of the optical device 100′ are connected between one side of the support base 110 and the lens module 140, such that the lens module 140 thereof can have increased distance of travel. Namely, in this embodiment, the focus range of the lens module 140 is increased.

Structure, disposition, and function of other elements in this embodiment are the same as those in the first embodiment, and explanation thereof is omitted for simplicity.

Moreover, the optical devices 100 and 100′ may employ a single magnetic member having an annular profile and surrounding the lens module 140.

Additionally, by feedback of the image sensor 180, the optical devices 100 and 100′ can automatically switch the current direction in the coil 160 using an actuator (not shown), such that automatic focus movement of the lens module 140 is performed.

In conclusion, the disclosed optical devices have many advantages. The disclosed optical devices have simplified structure, such that the size and manufacturing costs thereof are reduced. Moreover, as the lens module can be fixed in a focus position in the absence of a holding current, power consumption of the optical devices is reduced. Portability or duration of the optical devices is thus enhanced. Additionally, as the optical devices can perform multi-focusing operations, an increased range of depth of field is obtained. Namely, images in far, middle, and near positions can be clearly captured by the optical devices.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical device, comprising:
a support base;
a first yoke connected to the support base;
a second yoke connected to the support base and opposing the first yoke;
a lens module movably disposed in the support base and between the first and second yokes;
at least one magnetic member connected to the lens module and disposed between the first and second yokes;
a coil connected to the support base and disposed between the first and second yokes, wherein the coil surrounds the magnetic member and lens module and is separated from the magnetic member; and
at least one elastic suspension rod connected to the support base and lens module, supporting the lens module.

2. The optical device as claimed in claim 1, further comprising an image sensor disposed in the exterior of the support base and adjacent to the first yoke.

3. The optical device as claimed in claim 1, further comprising an image sensor disposed in the exterior of the support base and adjacent to the second yoke.

4. The optical device as claimed in claim 1, wherein the magnetic member surrounds the lens module.

5. The optical device as claimed in claim 1, wherein the support base comprises a first opening and a second opening opposite thereto, the first yoke surrounds the first opening, the second yoke surrounds the second opening, and the lens module is between the first and second openings.

6. The optical device as claimed in claim 1, wherein the lens module comprises a lens housing and a lens disposed therein.
